(19) United States
(12) Patent Application Publication
(10) Pub. No.: US 2008/0138729 A1
(43) Pub. Date: Jun. 12, 2008

(54) ELECTROPHOTOGRAPHIC PHOTORECEPTOR AND ELECTROPHOTOGRAPHIC IMAGING APPARATUS HAVING THE SAME

(75) Inventors: Moto Makino, Suwon-si (KR); Youne-don Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/945,578

(22) Filed: Nov. 27, 2007

(30) Foreign Application Priority Data
Dec. 7, 2006 (KR) 2006-124043

(51) Int. Cl. G03G 5/04

(52) U.S. Cl. 430/64

(57) ABSTRACT

An electrophotographic photoreceptor including an undercoat layer and a photosensitive layer formed on an electrically conductive substrate, the undercoat layer including an inorganic particle and a nylon binder resin having saturation water absorptivity of 3% or less, and the photosensitive layer including a phthalocyanine-based pigment as a charge generating material, and an electrophotographic imaging apparatus having the same.

### CROSS-REFERENCE TO RELATED APPLICATIONS

This application claims priority under 35 U.S.C. §119(a) from Korean Patent Application No. 10-2006-0124043, filed on Dec. 7, 2006, in the Korean Intellectual Property Office, the disclosure of which is incorporated herein in its entirety by reference.

### BACKGROUND OF THE INVENTION

1. Field of the Invention

The present general inventive concept relates to an electrophotographic photoreceptor and an electrophotographic imaging apparatus having the same, and more particularly, to an electrophotographic photoreceptor having reduced environmental dependency in electrical properties and imaging properties and an electrophotographic imaging apparatus having the same.

2. Description of the Related Art

In electrophotographic devices, such as laser printers, photocopiers, etc., electrophotographic photoreceptors having a photosensitive layer formed on an electrically conductive substrate and that are in the form of a plate, a disk, a sheet, a belt, or a drum, or the like form an image as follows. First, a surface of the photosensitive layer is uniformly and electrostatically charged, and then the charged surface is exposed to a pattern of light, thus forming the image. The light exposure selectively dissipates the charge in the exposed regions where the light strikes the surface, thereby forming a pattern of charged and uncharged regions, referred to as a latent image. Then, a wet or dry toner is provided in the vicinity of the latent image, and toner droplets or particles collect in either the charged or uncharged regions to form a toner image on the surface of the photosensitive layer. The resulting toner image may be transferred to a suitable final or intermediate receiving surface, such as paper, or the photosensitive layer may function as the final receptor to receive the image.

Electrophotographic photoreceptors are widely categorized into two types according to a structure of the photosensitive layer. The first is a laminated-type electrophotographic photoreceptor having a laminated structure including a charge generating layer (CGL) comprising a binder resin and a charge generating material (CGM), and a charge transporting layer (CTL) comprising a binder resin and a charge transporting material (usually, a hole transporting material (HTM)). In general, the laminated-type electrophotographic photoreceptor is used in fabrication of a negative (−) type electrophotographic photoreceptor. The other type of electrophotographic photoreceptor is a single layered-type in which a binder resin, a CGM, an HTM, and an electron transporting material (ETM) are included in a single layer. In general, the single layered-type electrophotographic photoreceptor is used in fabrication of a positive (+) type electrophotographic photoreceptor.

Such a photosensitive layer of an electrophotographic photoreceptor is formed on a conductive substrate. Additionally, an undercoat layer may be formed between the conductive substrate and the photosensitive layer. The undercoat layer improves imaging properties by preventing holes from being injected into the photosensitive layer from the conductive substrate, improves adhesion between the conductive substrate and the photosensitive layer, prevents dielectric breakdown of the photosensitive layer, covers surface defects of the conductive substrate and the like. As such an undercoat layer, an inorganic layer such as an aluminium anodic oxide layer (an alumite layer), an aluminium oxide layer, an aluminium hydroxide layer or the like have been widely used. However, recently, an undercoat layer comprising inorganic particles and a polymer binder resin has become widely used in order to reduce costs.

A thermosetting resin and a thermoplastic resin may be both used as a binder resin of the undercoat layer. When the thermoplastic resin is used, a process of drying and cooling the undercoat layer after a coating process is not required. In addition, it is economical because the shelf life of a coating solution becomes longer. Of thermoplastic resins, an alcohol-soluble nylon resin is widely used, taking into account its suitable properties of adhesion to a substrate, solvent resistance, a coating property, and an electrical barrier property.

Japanese Patent Laid-open Publication No. hei 7-43544 discloses an electrophotographic photoreceptor comprising an undercoat layer formed of a copolymer polyamide resin that has a saturation water absorptivity of 10% or less at 20° C., and contains 30-70% by weight of at least one of Nylon 11 and Nylon 12. However, when a nylon resin, as one of the thermoplastic resins above, which comprises only an amide component having linear (straight chain) repeating unit structures, such as Nylon 6, 66, 11, 12, and 610, is used, if the linear nylon resin has a high saturation water absorptivity, environmental dependency of electrical properties and imaging properties of an electrophotographic photoreceptor may tend to increase. On the other hand, if the linear nylon resin has a low saturation water absorptivity, it is easily gelled and precipitated so that a composition to form an undercoat layer has bad dispersion stability, even though environmental dependency of electrical properties and imaging properties of an electrophotographic photoreceptor may tend to be improved.

As a solution for improving the environmental dependency described above, there has been disclosed a technique of forming an undercoat layer using a composition that comprises a combination of an alcohol-soluble nylon resin and metal oxide particles that are hydrophobically surface-treated with silicone or the like in order to reduce water adsorped on surface.

In addition, to obtain an electrophotographic photoreceptor that can effectively satisfy general properties required for an undercoat layer in order to address such problems described above, a nylon resin having specific molecular structures is used as a binder resin of the undercoat layer in an electrophotographic photoreceptor. The electrophotographic photoreceptor using the nylon resin is disclosed in the following patent applications.

U.S. Pat. No. 5,173,385 discloses an electrophotographic photoreceptor including an undercoat layer that uses a copolymer polyamide comprising a diamine constituent with a specific structure containing a cyclohexyl group as a binder resin.

Japanese Patent Laid-open Publication No. 2003-316047 discloses electrophotographic photoreceptor including an undercoat layer that uses an amide component having repeating unit structures which are not linear structures as a binder resin.

The non-linear type alcohol-soluble nylon resin, such as discussed above, has lower saturation water absorptivity so that environmental dependency of the electrical properties and imaging properties can be improved. However, a monomer having a specific structure has to be used, thereby leading to cost increases.

### SUMMARY OF THE INVENTION

The present general inventive concept provides an electrophotographic photoreceptor including an undercoat layer using a linear alcohol-soluble nylon resin as a binder resin to improve an environmental dependency.

The present general inventive concept also provides an electrophotographic photoreceptor including an undercoat layer that uses a linear alcohol-soluble nylon resin as a binder resin to prevent a ghost phenomenon even at low temperature and low humidity conditions.

The present general inventive concept also provides an electrophotographic imaging apparatus having the electrophotographic photoreceptor.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing electrophotographic photoreceptor comprising an undercoat layer and a photosensitive layer formed on an electrically conductive substrate, wherein the undercoat layer comprises inorganic particles and a nylon binder resin having saturation water absorptivity of 3% or less, and the photosensitive layer comprises a titanyl phthalocyanine-based pigment as a charge generating material.

The foregoing and/or other aspects and utilities of the present general inventive concept may also be achieved by providing an electrophotographic imaging apparatus comprising an electrophotographic photoreceptor, a charging unit that charges a photosensitive layer of the electrophotographic photoreceptor, a light exposure unit that forms a latent image on a surface of the photosensitive layer of the electrophotographic photoreceptor by light exposure using laser light, and a developer that develops the latent image, wherein the electrophotographic photoreceptor comprises an undercoat layer and a photosensitive layer formed on a electrically conductive substrate, the undercoat layer comprising inorganic particles and a nylon binder resin having saturation water absorptivity of 3% or less, and the photosensitive layer comprising a titanyl phthalocyanine-based pigment as a charge generating material.

The foregoing and/or other aspects and utilities of the present general inventive concept may also be achieved by providing an electrophotographic photoreceptor usable in an electrophotographic imaging apparatus, including an electrically conductive substrate, a photosensitive layer formed on electrically conductive substrate, and an undercoat layer disposed between the electrically conductive substrate and the photosensitive layer, wherein the undercoat layer includes a linear alcohol-soluble nylon binder resin having a saturation water absorptivity of about 3% or less.

The undercoat layer may further include inorganic particles.

The linear alcohol-soluble nylon binder resin may include a nylon binder resin having linear aliphatic hydrocarbon residues between amide bonds in a molecular structure of the nylon binder resin.

The linear alcohol-soluble nylon binder resin may not include a nylon binder resin having cyclic hydrocarbons or aromatic hydrocarbon residues between amide bonds in a molecular structure of the nylon binder resin.

The undercoat layer may include about 6% by weight nylon binder resin and about 15% by weight of inorganic particles with respect to a total weight of an undercoat layer composition.

The undercoat layer may be 0.05 to 10 μm thick.

The undercoat layer may further include at least one of a dispersion stabilizer, a plasticizer, a surface modifier, an anti-oxidant, and an anti-photodegradation agent.

The undercoat layer may include an inorganic particles to nylon binder resin weight ratio of about 1.5 to 1.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a diagram illustrating an electrophotographic imaging apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

The electrophotographic photoreceptor according to an embodiment of the present general inventive concept may include an undercoat layer and a photosensitive layer which are deposited on an electrically conductive substrate. The undercoat layer may include metal oxide particles and a nylon binder resin having a saturation water absorptivity of 3.0% or less, and the photosensitive layer may include a titanyl phthalocyanine-based pigment as a charge generating material.

The electrophotographic photoreceptor according to the embodiment of the present general inventive concept has improved environmental dependency, and particularly, has excellent imaging properties even at a low temperature and low humidity conditions, even though it uses a linear alcohol-soluble nylon binder as a binder resin of the undercoat layer. This improvement is considered largely due to the use of a linear alcohol-soluble nylon resin having saturation water absorptivity of 3% or less. In particular, the linear alcohol-soluble nylon resin that is used as a binder resin of an undercoat layer of the electrophotographic photoreceptor according to the embodiment of the present general inventive concept has a low saturation water absorptivity and an excellent dispersion stability, and thus a composition to form an undercoat layer is difficult to be gellized and precipitated. Accordingly, this can improve the manufacture productivity of the electrophotographic photoreceptor.

In the embodiment of the present general inventive concept, the term “linear nylon resin” refers to a linear aliphatic hydrocarbon residue between amide bonds in a molecular structure of the nylon resin, and not to a cyclic hydrocarbon residue or an aromatic hydrocarbon residue.

The electrophotographic photoreceptor according to the current embodiment of the present general inventive concept may include an undercoat layer and a photosensitive layer that are formed on the electrically conductive substrate. The electrically conductive substrate may be a metal material, such as aluminum, stainless steel, copper, nickel, or the like; or an insulating substrate, such as a polyester film, paper, glass or the like having an electrically conductive layer such as aluminum, copper, palladium, tin oxide, indium oxide, or the like. The electrically conductive substrate can be in a form of a drum, pipe, belt, plate, or the like.

The undercoat layer can be formed between the electrically conductive substrate and the photosensitive layer. The undercoat layer includes metal oxide particles and a linear nylon binder resin having a saturation water absorptivity of 3.0% or less, and preferably, 2.5% or less.

The nylon binder resin may be any linear nylon binder resin having saturation water absorptivity of 3.0% or less, but the present general inventive concept is not limited thereto. Examples of the nylon binder resin may include a nylon copolymer resin, such as a nylon terpolymer like nylon 6-66-610, a nylon tetrapolymer like nylon 6-66-610-612, and the like. Also, the nylon binder resin may be a nylon alloy having saturation water absorptivity of 3.0% or less, which may be obtained by mixing these nylon terpolymers and/or nylon tetrapolymers with nylon 6, nylon 66, nylon 11, nylon 12, nylon 610, and/or nylon 612 in a predetermined amount, or nylon alloy having saturation water absorptivity of 3.0% or less, which is obtained by mixing nylon 6, nylon 66, nylon 11, nylon 12, nylon 610, and/or nylon 612 in a predetermined amount. Of those nylon binder resins, the nylon terpolymer, such as nylon 6-66-610, may be selected in terms of solubility against an organic solvent, adhesion to an electrically conductive substrate, mechanical properties, saturation water absorptivity, and cost. Here, saturation water absorptivity is measured by an ASTM D570 method, and refers to a saturation value of water absorption that increases over time after a sample is immersed into water at 20° C. When the saturation water absorptivity of the nylon binder resin is greater than 3.0%, environmental dependency of electrical properties and imaging properties of an electrophotographic photoreceptor increases, and also a property of preventing a ghost phenomenon at a low temperature and a low humidity condition particularly decreases. Examples of the nylon copolymer resin that satisfies such requirements include a nylon terpolymer, such as nylon 6-66-610 that is available as product SVP-651 obtained from Shakespeare Co., Ltd.

When a composition to form an undercoat layer, using an inorganic particle and the nylon binder resin, is prepared to include 6% by weight of the nylon binder resin such as nylon 6-66-610 that is available as product SVP-651 and 9% by weight of the inorganic particle in a mixed alcohol solvent of methanol/1-propanol=8/2 (weight ratio), the composition having the total solids content of 15% by weight, the composition may preferably have a viscosity increase of 10% or less, more preferably 7% or less, and most preferably 3% or less, after 1 month has passed after its preparation.

The molecular weight of the nylon binder resin used in the present general inventive concept are not particularly limited to a certain value, and may be any value as long as it can form a polymer film on an electrically conductive substrate. For example, the nylon binder resin may have a number average molecular weight of 10,000-20,000.

The undercoat layer of the present general inventive concept comprises inorganic particles such as metal oxide particles that are dispersed in the nylon binder resin. Examples of metal oxides that may be to form the metal oxide particles are titanium oxide, iron oxide, tin oxide, aluminum oxide, zinc oxide, cerium oxide, chromium oxide, magnesium oxide, silicon oxide, zirconium oxide and the like. Preferably, the metal oxide particle may be an N-type semiconductor particle. The N-type semiconductor particle is a particle in which an electrically conductive carrier is an electron. That is, since the electrically conductive carrier is an electron, an undercoat layer that contains the N-type semiconductor particle dispersed in the binder resin efficiently blocks holes from being injected from an electrically conductive substrate, and also does not block electrons from being injected from a photosensitive layer as much. The N-type semiconductor particle may be titanium oxide, zinc oxide, tin oxide, aluminum oxide or the like, and may be preferably titanium oxide in the present general inventive concept.

The average primary particle diameter of the inorganic particle of the present general inventive concept may be 10-200 nm, and preferably 15-100 nm in average primary particle diameter. When the average primary particle diameter of the inorganic particle is less than 10 nm, the inorganic particles easily aggregate and precipitate. On the other hand, when the average primary particle diameter of the inorganic particle is greater than 200 nm, the inorganic particle of a composition to form the undercoat layer may also be easily precipitated. This causes bad dispersion uniformity of the inorganic particle on the undercoat layer. The shape of the inorganic particle of the present general inventive concept includes a dendrite shape, a needle shape, a granular shape, or the like. When the inorganic particle having such a shape is titanium oxide, it may have a crystalline type, such as an anatase type and a rutile type. Any titanium oxide having those types may be used, and at least the two crystalline types of titanium oxide may be used in combination. Of titanium oxide having those crystalline types, titanium oxide having a rutile type and a granular shape may be used. An amorphous type titanium oxide may also be used. Meanwhile, to improve dispersibility, environmental dependency and electrical properties, an inorganic particle that is surface-treated with alumina, zirconia, silica and/or silicone may be used.

An amount ratio of the nylon binder resin to the inorganic particles is not particularly limited. However, the amount of the inorganic particles may be 20-350 parts by weight based on 100 parts by weight of the nylon binder resin, and preferably 30-250 parts by weight, to provide dispersion stability and electrical properties of the composition to form an undercoat layer. By maintaining the inorganic particles in those ranges, the inorganic particles may have good dispersion stability and the photosensitive layer may have good electrical properties.

The undercoat layer may have a thickness of 0.05-10 μm, preferably 0.1-5 μm and more preferably 0.1-2 μm. When the thickness of the undercoat layer is less than 0.05 μm, the undercoat layer may be too thin to substantially block holes and prevent a dielectric breakdown of an electrophotographic photoreceptor. On the other hand, when the thickness of the undercoat layer is greater than 10 μm, electrical properties and imaging properties of an electrophotographic photoreceptor deteriorate at low temperature and low humidity condition.

A laminated-type or single layered-type photosensitive layer can be formed on the undercoat layer. However, preferably, the photosensitive layer may be a laminated-type photosensitive layer including a charge generating layer and a charge transporting layer that are sequentially formed in order to improve imaging properties. That is, the photosensitive layer of the present general inventive concept may be a laminated-type photosensitive layer including a charge generating layer that is formed on the undercoat layer and includes a phthalocyanine-based charge generating material dispersed or dissolved in a binder resin and a charge transporting layer that is formed on the charge generating layer and includes a charge transporting material dispersed or dissolved in a binder resin.

The charge generating layer may have a thickness of 0.05˜2 μm, and preferably 0.1-1.0 μm. When the thickness of the charge generating layer is less than 0.05 μm, photosensitivity may be insufficient. On the other hand, when the thickness of the charge generating layer is greater than 2.0 μm, electrical and imaging properties may tend to deteriorate. In the charge generating layer according to an embodiment of the present general inventive concept, an amount of the charge generating material and binder resin is not particularly limited, and may be selected within an amount range that is conventionally used in the art, if necessary. For example, the amount of the charge generating material may be 10-500 parts by weight based on 100 parts by weight of the binder resin, and preferably 50-300 parts by weight. When the amount of the charge generating material is less than 10 parts by weight, a photosensitivity may be insufficient due to an insufficient amount of charge generated, and thus a residual potential may become higher. On the other hand, when the amount of the charge generating material is greater than 500 parts by weight, an amount of the binder resin of the photosensitive layer may be small, and thus adhesion to the undercoat layer can be deteriorated and the dispersion stability of the charge generating material can be decreased.

The phthalocyanine-based charge generating material may be a metal-free phthalocyanine-based pigment, a titanyloxy phthalocyanine-based pigment, a titanyl phthalocyanine pigment, a copper phthalocyanine pigment, a hydroxygallium phthalocyanine-based pigment, or the like to provide good light efficiency. The phthalocyanine-based charge generating material may be used alone or be used as a combination of at least two types of phthalocyanine-based charge generating materials in order to have an absorption wavelength in a desired region. In addition to the phthalocyanine-based charge generating material, an organic pigment, such as a perylene-based pigment, a bisazo-based pigment, a bisbenzoimidazole-based pigment, a metal-free naphthalocyanine-based pigment, a metal naphthalocyanine-based pigment, a squaline-based pigment, a squarylium-based pigment, a trisazo-based pigment, an indigo-based pigment, an azulenium-based pigment, a quinone-based pigment, a cyanine-based pigment, a pyrylium-based pigment, an anthraquinone-based pigment, a triphenylmethane-based pigment, a threne-based pigment, a toluidine-based pigment, a pyazolin-based pigment, or a quinachridone-based pigment may also be used.

The charge transporting layer may have a thickness of 2-50 μm, preferably 5-40 μm, and more preferably 10-35 μm. When the thickness of the charge transporting layer is less than 2 μm, the thickness thereof may be too small, and thus the charge transporting layer may not sufficiently carry out its function. On the other hand, when the thickness of the charge transporting layer is greater than 50 μm, imaging properties tend to deteriorate. In the charge transporting layer according to an embodiment of the present general inventive concept, the amount of the charge transporting material and binder resin is not particularly limited, and may be selected within the amount range that is conventionally used in the art, if necessary. For example, the amount of the charge transporting material may be 10-300 parts by weight based on 100 parts by weight of the binder resin, and preferably 30-120 parts by weight. When the amount of the charge transporting material is less than 10 parts by weight, photosensitivity is insufficient due to an insufficient charge transporting ability, and thus residual potential tends to become higher. On the other hand, when the amount of the charge transporting material is greater than 300 parts by weight, an amount of the binder resin of the photosensitive layer is small, and thus mechanical strength tends to be reduced.

The charge transporting material that is dispersed or dissolved in a binder resin of the charge transporting layer may be a hole transporting material and/or an electron transporting material. The hole transporting material may be a low molecular compound, for example, pyrene-based, carbazole-based, hydrazone-based, oxazole-based, oxadiazole-based, pyrazoline-based, arylamine-based, arylmethane-based, benzidine-based, thiazole-based, stylbene-based, butadiene-based compound, or the like. In addition, the hole transporting material may be a polymer compound, for example, poly-N-vinylcarbazole, halogenized poly-N-vinylcarbazole, polyvinylpyrene, polyvinylanthracene, polyvinylacrydine, a pyrene-formaldehyde resin, an ethylcarbazole-formaldehyde resin, a triphenylmethane polymer, polysilane, or the like. The electron transporting material may be a low molecular compound having an electron withdrawing property, for example, benzoquinone-based, tetracyanoethylene-based, tetracyanoquinomethane-based, fluorenone-based, xanthone-based, phenanthraquinone-based, phthalic anhydride-based, diphenoquinone-based, stilbenequinone-based, naphthalene-based, thiopyrane-based compound, or the like. However, the electron transporting material is not limited thereto, and a polymer compound having an electron transporting ability and a pigment having an electron transporting ability, or the like may be used.

In the electrophotographic photoreceptor of the present general inventive concept, the charge transporting material described above may be used alone or be used a of at least two types of transporting material.

The binder resin that may be used in the electrophotographic photoreceptor according to an embodiment of the present general inventive concept may include polycarbonate, polyester, a methacryl resin, an acryl resin, polyvinylchloride, polyvinylidenechloride, polystyrene, polyvinylacetate, a styrene-butadiene copolymer, a vinylidenechloride-acrylonitrile polymer, a vinylchloride-vinylacetate copolymer, a vinylcholoride-vinylacetate-maleic anhydride copolymer, a silicone resin, a silicone-alkid resin, a phenol-formaldehyde resin, a styrene-alkid resin, poly-N-vinylcarbazole, polyvinylbutyral, polyvinylformal, polysulfon, casein, gelatin, polyvinyl alcohol, ethylcellulose, a phenolic resin, polyamide, carboxymethyl cellulose, a vinylidenechloride-based polymer latex, polyurethane, or the like, but is not limited thereto. Such a binder resin may be used alone or be used as a combination of at least two types of binder resin.

The binder resin for the charge transporting layer can be a polycarbonate resin, particularly polycarbonate-Z derived from cyclohexylidene bisphenol or polycarbonate-C derived from methyl bisphenol A, rather than polycarbonate-A derived from bisphenol A, since the polycarbonate-Z and polycarbonate-C are more resistant to abrasion.

In the photosensitive layer and the undercoat layer of the present general inventive concept, additives, such as a dispersion stabilizer, a plasticizer, a surface modifier, an anti-oxidant, an anti-photodegradation agent, or the like, in addition to the binder resin described above may be used.

The plasticizer may be biphenyl, biphenyl chloride, terphenyl, dibutyl phthalate, diethyleneglycol phthalate, dioctyl phthalate, triphenyl phosphate, methylnaphthalene, benzophenone, chlorided paraffin, polypropylene, polystyrene, fluoro-hydrocarbon, or the like.

The surface modifier may be silicone oil, a fluoro-resin, or the like.

The anti-oxidant may be a phenol-based compound, a sulfur-based compound, a phosphorous-based compound, an amine-based compound, or the like.

The anti-photodegradation agent may be benzotriazoles, benzophenones, hindered amines, or the like.

An electrophotographic imaging apparatus according to an embodiment of the present general inventive concept may include the electrophotographic photoreceptor of the present general inventive concept.

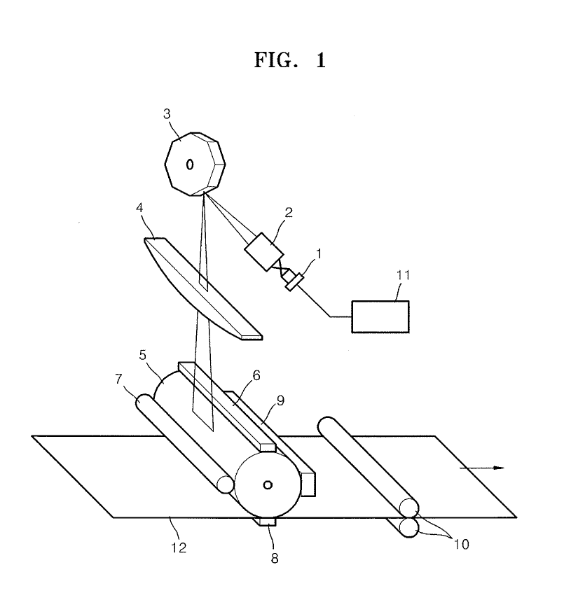

FIG. 1 schematically illustrates an electrophotographic image forming apparatus according to an embodiment of the present general inventive concept. Referring to FIG. 1, reference numeral 1 refers to a semiconductor laser. Laser light that is signal-modulated by a control circuit 11 according to image information, is collimated by an optical correction system 2 after being radiated and performs scanning while being reflected by a polygonal rotatory mirror 3. The laser light is focused on a surface of an electrophotographic photoreceptor 5 by an f-θ lens 4 and exposes the surface according to the image information. Since the electrophotographic photoreceptor may be already charged by a charging apparatus 6, an electrostatic latent image is formed by the exposure, and then becomes visible by a developing apparatus 7. The visible image is transferred to an image receptor 12, such as paper, by a transferring apparatus 8, and is fixed in a fixing apparatus 10 and provided as a print result. The electrophotographic photoreceptor can be used repeatedly by removing coloring agent that remains on the surface thereof by a cleaning apparatus 9. The electrophotographic photoreceptor here is illustrated in the form of a drum, however, as described above, the present general inventive concept is not limited thereto, and it may also be in the form of a sheet, a belt, or the like.

Hereinafter, the present general inventive concept will be described in further detail with reference to the following examples. These examples are for illustrative purposes only and are not intended to limit the scope of the present general inventive concept.

### EXAMPLES

### Preparation of Coating Composition 1 to Form an Undercoat Layer

30 g of nylon 6-66-610 terpolymer (Product: SVP-651, obtained from Shakespeare Co., Ltd) having saturation water absorptivity of 2.5% was dissolved in 235 g of a mixed alcohol solvent (methanol/1-propanol=8/2 (weight ratio)) to obtain a nylon copolymer solution. 265 g of a mixed alcohol slurry (solids content 17.0 weight %) of a titanium dioxide particle (Product: TTO-55N, obtained from Ishihara Industries Co, Ltd.) that had an average primary particle diameter of 30-50 nm and was not surface-treated, which had been dispersed in advance by a ball mill was added to the nylon copolymer solution and mixed. The mixture was dispersed more using an ultrasonic wave to obtain coating composition 1 to form an undercoat layer, which had a solids content of 15 weight % and included a titanium dioxide particle (TTO-55N)/nylon copolymer ratio of 1.5/1 (weight ratio).

### Preparation of Coating Composition 2 to Form an Undercoat Layer

Coating composition 2 to form an undercoat layer, which had a solids content of 15% by weight and included a titanium dioxide particle (TTO-55N)/nylon copolymer ratio of 1.5/1 (weight ratio) was prepared in the same manner as the method of preparing coating composition 1 to form an undercoat layer, except that a nylon 6-66-610-12 tetrapolymer (Product: AMI LAN CM8000, obtained from Toray Co., Ltd.) having saturation water absorptivity of 3.4% was used instead of the SVP-651 nylon copolymer.

### Preparation of Coating Composition 3 to Form an Undercoat Layer

Coating composition 3 to form an undercoat layer, which had a solids content of 15% by weight and included a titanium dioxide particle (TTO-55N)/nylon copolymer ratio of 1.5/1 (weight ratio) was prepared in the same manner as the method of preparing coating composition 1 to form an undercoat layer, except that a nylon 6-66-610 terpolymer (Product: TT65SI, obtained from Shakespeare Co., Ltd.) having saturation water absorptivity of 3.1% was used instead of the SVP-651 nylon copolymer.

### Preparation of Coating Composition 4 to Form an Undercoat Layer

Coating composition 4 to form an undercoat layer, which had a solids content of 15% by weight and included a titanium dioxide particle (TTO-55N)/nylon copolymer ratio of 1.5/1 (weight ratio) was prepared in the same manner as the method of preparing coating composition 1 to form an undercoat layer, except that a nylon 6-66-610 terpolymer (Product: Elvamide 8061, obtained from Dupont Co., Ltd.) having saturation water absorptivity of 3.1% was used instead of the SVP-651 nylon copolymer.

### Preparation of a Coating Composition to Form a Charge Generating Layer (CGL)

9.5 parts by weight of T-type metal-free phthalocyanine particles and 0.5 parts by weight of γ-type titanyloxy phthalocyanine (y-TiOPc) particles were mixed with 5 parts by weight of polyvinylbutyral (PVB) binder resin (PVB 6000-C, DENKI KAGAKU KOGYO KABUSHIKI KAISHA) and 100 parts by weight of tetrahydrofurane (THF). The mixture was sand milled for about two hours and then ultrasonic-treated to obtain coating composition to form a CGL.

### Preparation of a Coating Composition to Form a Charge Transporting Layer (CTL)

51 parts by weight of Compound (1) below and 27 parts by weight of Compound (2) below as a charge transporting material, 100 parts by weight of a polycarbonate resin (Product: B500, obtained from Idemitsu Kosan Co., Ltd.), and 0.1 parts by weight of silicone oil (Product: KF-50, obtained from Shin-Etsu Co., Ltd. in Japan) were dissolved in a mixed solvent of 534 parts by weight of THF and 178 parts by weight of toluene to obtain a coating composition to form a CTL.

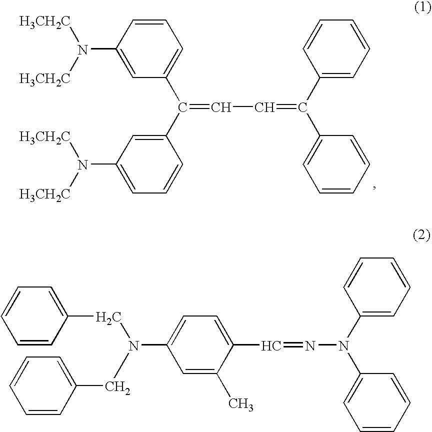

### Measurement of Viscosity Increase Rate

Each of the compositions to form an undercoat layer prepared above was sealed in a vial and then stored at room temperature. Then, a state of the compositions to form an undercoat layer after being stored was observed. As can be seen in Table 1 below, the compositions 1 and 2 to form an undercoat layer showed little viscosity increase in spite of being stored for one month or more. However, the compositions 3 and 4 to form an undercoat layer showed gellation within 1 week after being stored.

TABLE 1

| | Immediate | |
|---|---|---|
| Coating composition | after preparation | After 30 days |
| Viscosity of composition 1 for | 13.0 | 12.7 |
| undercoat layer (cP) | | |
| Viscosity of composition 2 for | 10.7 | 10.5 |
| undercoat layer (cP) | | |

### Example 1

Coating composition 1, which had been prepared one week earlier, was coated using an immersion coating method on an aluminum drum having an external diameter of 24 mm, a length of 248 mm and a thickness of 1 mm and then dried to form an undercoat layer having a film thickness of about 1.2 μm. The coating composition to form a CGL was coated using an immersion coating method on the aluminum drum and then dried to form a charge generating layer having a film thickness of about 0.4 μm on the undercoat layer. The coating composition to form a CTL was coated using an immersion coating method on the aluminum drum and then dried to form charge transporting layer having a film thickness of about 20 μm on the CGL. The photoreceptor drum thus obtained is referred to as Photoreceptor 1.

### Comparative Example 1

Photoreceptor 2 was prepared in the same manner as in Example 1, except that coating composition 2 to form an undercoat layer, which had been prepared one week earlier, was used instead of coating composition 1 to form an undercoat layer.

### Comparative Example 2

It was intended to form an undercoat layer using coating composition 3 to form an undercoat layer which had been prepared one week earlier instead of coating composition 1 to form an undercoat layer. However, coating composition 3 had showed gelling so that an undercoat layer could not be formed using it. Therefore, a photoreceptor could not be prepared.

### Comparative Example 3

It was intended to form an undercoat layer using coating composition 4 to form an undercoat layer which had been prepared one week earlier instead of coating composition 1 to form an undercoat layer. However, coating composition 4 had showed gelling so that an undercoat layer could not be formed using it. Therefore, a photoreceptor could not be prepared.

### Evaluation of Electrical Properties

To stabilize properties of photoreceptors 1 and 2 obtained above at an early time, photoreceptors 1 and 2 were stored for 5 days under the conditions of 50° C. and 80% relative humidity. Subsequently, electrical properties of photoreceptors 1 and 2 were measured using a drum type photoreceptor evaluation apparatus (available from QEA INC., “PDT-2000”) under conditions of 23° C. and 50% relative humidity as follows.

Each photoreceptor was charged at a corona voltage of −7.5 kV and at a relative speed of 100 mm/sec of the charging unit and the photoreceptor so that the initial surface potential (Vo) of the photoreceptors could be −800V. Subsequently, one second later, the residual potential (Vr) of the photoreceptors was measured when the photoreceptors were exposed to light by irradiating a monochromatic light having a wavelength of 780 nm and energy of 1.0 μJ/cm2 on the surface of a photoreceptor for one second. In addition, when the monochromatic light having a wavelength of 780 nm was irradiated to the photoreceptors, a relationship of exposure energy versus surface potential of the photoreceptors was measured to obtain E_{1/2} (μJ/cm2) and E₁₀₀ (μJ/cm2). The results are illustrated in Table 2 below. In Table 2, E_{1/2} (μJ/cm2) denotes exposure energy that is required in order for the surface potential of the photoreceptors to become half of the initial potential (Vo) thereof. E₁₀₀ (μJ/cm2) denotes to exposure energy that is required in order for the photoreceptors to have a surface potential of −100V. The lower the values of E_{1/2} (μJ/cm2) and E₁₀₀ (μJ/cm2), the higher the photosensitivity of the photoreceptors.

Table 2 illustrates the results of evaluating electrical properties of photoreceptors 1 and 2 prepared in Example 1 and Comparative Example 1. In Table 2, DD₅(%) refers to surface potential retention rate after the photoreceptors were charged and then left to sit for five seconds in the dark.

TABLE 2

| | | | E₁₀₀ | |
|---|---|---|---|---|
| Photoreceptor | DD₅ (%) | E_{1/2} (μJ/cm2) | (μJ cm2/) | Vr (−V) |
| Example 1 | 96.9 | 0.364 | 0.816 | 7 |
| (Photoreceptor 1) | | | | |
| Comparative Example 1 | 96.7 | 0.344 | 0.774 | 7 |
| (Photoreceptor 2) | | | | |
| Comparative Example 2 | N.A. | N.A. | N.A. | N.A. |
| Comparative Example 3 | N.A. | N.A. | N.A. | N.A. |

Referring to Table 2, it can be seen that the photoreceptors of Example 1 and Comparative Example 1 each exhibits electrical properties good enough to prepare a practical electrophotographic photoreceptor.

### Measurement of Imaging Properties

The imaging properties of each of the photoreceptors were measured using a remodeled measurement device which was prepared by mounting the photoreceptors on a commercially available laser printer (Product: SCX-4521, available from Samsung Electronics Co., Ltd) under conditions of 10° C./20% relative humidity (L/L), 23° C./50% relative humidity (N/N), and 32° C./80% relative humidity (H/H) as follows.

### Measurement of Image Density (ID)

A regular black square pattern having a side length of 10 mm was printed on a sheet of A4 white paper under each of the above conditions. The image densities of the printed patterns were measured using a reflection densitometer (available from Macbath, Product: RD-918). The image density was measured as a relative density that sets the reflection density of a sheet of blank paper to “0”. Under the conditions of low temperature and low humidity (L/L), the image density was also measured after the pattern had been repeatedly printed.

### Background (BG) Measurement

The background (BG) of the A4 white paper on which the pattern was printed was observed with the naked eye to be evaluated on a basis as follows.

-: Hardly generated

[symbol] : Little generated

◯: Definitely generated

### Ghost Measurement

Printing was performed using an A4 paper in which the test image pattern of the letter “A” having a height of 20 mm was printed on a top portion of the paper. Then, a ghost phenomenon was determined according to whether the image pattern placed on a top portion of the paper was printed on a lower portion of the printed A4 paper (the lower portion corresponds to a portion that is separated from the top portion a distance greater than one rotation length of the photoreceptor drum). The determination standard of the ghost phenomenon was as follows. Under the conditions of low temperature and low humidity (L/L), the ghost phenomenon was also measured after the test image pattern had been repeatedly printed.

-: test image pattern hardly shown on a lower portion of A4 paper

[symbol] : test image pattern little shown on a lower portion of A4 paper

◯: test image pattern clearly shown on a lower portion of A4 paper

Table 3 below illustrates the results of evaluating initial imaging properties of the photoreceptors of Example 1 and Comparative Example 1.

TABLE 3

| | BG | | | ghost | | | ID | | |
|---|---|---|---|---|---|---|---|---|---|
| | N/N | H/H | L/L | N/N | H/H | L/L | N/N | H/H | L/L |
| Example 1 | — | — | — | — | — | — | 1.36 | 1.38 | 1.31 |
| (photoreceptor 1) | | | | | | | | | |
| Comparative | — | — | — | — | — | — | 1.38 | 1.41 | 1.33 |
| Example 1 | | | | | | | | | |
| (photoreceptor 2) | | | | | | | | | |
| Comparative | N.A. | N.A. | N.A. | N.A. | N.A. | N.A. | N.A. | N.A. | N.A. |
| Example 2 | | | | | | | | | |
| Comparative | N.A. | N.A. | N.A. | N.A. | N.A. | N.A. | N.A. | N.A. | N.A. |
| Example 3 | | | | | | | | | |

Referring to Table 3, it can be seen that the photoreceptors of Example 1 and Comparative Example 1 each exhibits imaging properties enough to prepare a practical electrophotographic photoreceptor.

Table 4 below represents the results of measuring image density of the photoreceptors of Example 1 and Comparative Example 1 under the conditions of low temperature and low humidity (L/L) after a test image had been repeatedly printed.

TABLE 4
image density

| | Printing number | | | | | | |
|---|---|---|---|---|---|---|---|
| | 0 | 500 | 1000 | 1500 | 2000 | 2500 | 3000 |
| Example 1 | 1.31 | 1.18 | 1.21 | 1.3 | 1.27 | 1.34 | 1.34 |
| (photoreceptor 1) | | | | | | | |
| Comparative | 1.33 | 1.21 | 1.26 | 1.31 | 1.34 | 1.34 | 1.34 |
| Example 1 | | | | | | | |
| (photoreceptor 2) | | | | | | | |
| Comparative | N.A. | N.A. | N.A. | N.A. | N.A. | N.A. | N.A. |
| Example 2 | | | | | | | |
| Comparative | N.A. | N.A. | N.A. | N.A. | N.A. | N.A. | N.A. |
| Example 3 | | | | | | | |

Referring to Table 4, it can be seen that the photoreceptors of Example 1 and Comparative Example 1 each practically does not show any change in image density even after a test image is repeatedly printed under the conditions of low temperature and low humidity (L/L).

Table 5 below represents the results of measuring the ghost phenomenon of the photoreceptors of Example 1 and Comparative Example 1 under the conditions of low temperature and low humidity (L/L) after a test image had been repeatedly printed.

TABLE 5
evaluation of ghost phenomenon

| | Printing number | | |
|---|---|---|---|
| | 0 | 1500 | 3000 |
| Example 1 | — | — | — |
| (photoreceptor 1) | | | |
| Comparative Example 1 | — | [symbol] | ∘ |
| (photoreceptor 2) | | | |
| Comparative Example 2 | N.A. | N.A. | N.A. |
| Comparative Example 3 | N.A. | N.A. | N.A. |

Referring to Table 5, it can be seen that the photoreceptor 1 of Example 1 practically does not show the ghost phenomenon under the conditions of low temperature and low humidity (L/L) even after a test image has been repeatedly printed. However, the photoreceptor 2 of Comparative Example 1 begins to show the ghost phenomenon under the same conditions of low temperature and low humidity (L/L) after 1,500 sheets of A4 paper has been printed.

As described above, the electrophotographic photoreceptor according to the present general inventive concept has reduced environmental dependency of electrical properties and imaging properties by using a linear alcohol-soluble nylon resin that has low saturation water absorptivity and is relatively inexpensive as a nylon binder resin of an undercoat layer. In particular, the electrophotographic photoreceptor can effectively prevent a ghost phenomenon even after repeatedly printing at a low temperature and low humidity condition (L/L). In addition, a composition to form an undercoat layer can have significantly improved dispersion stability (storage stability) using the nylon resin. As such, the manufacture productivity of the electrophotographic photoreceptor can be improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electrophotographic photoreceptor usable in an electrophotographic imaging apparatus, comprising:
an electrically conductive substrate;
a photosensitive layer formed on the electrically conductive substrate; and
an undercoat layer disposed between the electrically conductive substrate and the photosensitive layer,
wherein the undercoat layer comprises:
a linear alcohol-soluble nylon binder resin having a saturation water absorptivity of about 3% or less.

2. The electrophotographic photoreceptor of claim 1, wherein the undercoat layer further comprises inorganic particles.

3. The electrophotographic photoreceptor of claim 1, wherein the linear alcohol-soluble nylon binder resin comprises a nylon binder resin having linear aliphatic hydrocarbon residues between amide bonds in a molecular structure of the nylon binder resin.

4. The electrophotographic photoreceptor of claim 1, wherein the linear alcohol-soluble nylon binder resin does not comprise a nylon binder resin having cyclic hydrocarbons or aromatic hydrocarbon residues between amide bonds in a molecular structure of the nylon binder resin.

5. The electrophotographic photoreceptor of claim 2, wherein the amount of the inorganic particles is 20-350 parts by weight based on 100 parts by weight of the linear alcohol-soluble nylon binder resin in the undercoat layer.

6. The electrophotographic photoreceptor of claim 1, wherein the undercoat layer is 0.05 to 10 μm thick.

7. The electrophotographic photoreceptor of claim 2, wherein the undercoat layer is prepared from a composition including 6% by weight of a nylon 6-66-610 terpolymer binder resin and 9% by weight of the inorganic particle in a mixed alcohol solvent of methanol/1-propanol=8/2 (weight ratio), the composition having the total solids content of 15% by weight, and having a viscosity increase of 10% or less after 1 month has passed after its preparation.

8. The electrophotographic photoreceptor of claim 2, wherein the inorganic particles are metal oxide particles.

9. The electrophotographic photoreceptor of claim 2, wherein the inorganic particles are surface-treated with at least one of alumina, zirconia, silica and silicone.

10. The electrophotographic photoreceptor of claim 2, wherein the inorganic particles have an average primary particle diameter of about 10-200 nm.

11. An electrophotographic imaging apparatus comprising:
an electrophotographic photoreceptor;
a charging unit that charges a photosensitive layer of the electrophotographic photoreceptor;
a light exposure unit that forms a latent image on a surface of the photosensitive layer of the electrophotographic photoreceptor by light exposure using laser light; and
a developer that develops the latent image,
wherein the electrophotographic photoreceptor comprises:
an electrically conductive substrate,
a photosensitive layer formed on the electrically conductive substrate, and
an undercoat layer disposed between the electrically conductive substrate and the photosensitive layer,
wherein the undercoat layer comprises a linear alcohol-soluble nylon binder resin having a saturation water absorptivity of about 3% or less.

12. The electrophotographic imaging apparatus of claim 11, wherein the undercoat layer further comprises inorganic particles.

13. The electrophotographic imaging apparatus of claim 11, wherein the linear alcohol-soluble nylon binder resin comprises a nylon binder resin having linear aliphatic hydrocarbon residues between amide bonds in a molecular structure of the nylon binder resin.

14. The electrophotographic imaging apparatus of claim 11, wherein the linear alcohol-soluble nylon binder resin does not comprise a nylon binder resin having cyclic hydrocarbons or aromatic hydrocarbon residues between amide bonds in a molecular structure of the nylon binder resin.

15. The electrophotographic imaging apparatus of claim 12, wherein the amount of the inorganic particles is 20-350 parts by weight based on 100 parts by weight of the linear nylon binder resin in the undercoat layer.

16. The electrophotographic imaging apparatus of claim 11, wherein the undercoat layer is 0.05 to 10 μm thick.

17. The electrophotographic imaging apparatus of claim 12, wherein the undercoat layer is prepared from a composition including 6% by weight of a nylon 6-66-610 terpolymer binder resin and 9% by weight of the inorganic particle in a mixed alcohol solvent of methanol/1-propanol=8/2 (weight ratio), the composition having the total solids content of 15% by weight, and having a viscosity increase of 10% or less after 1 month has passed after its preparation.

18. The electrophotographic imaging apparatus of claim 12, wherein the inorganic particles are metal oxide particles.

19. The electrophotographic imaging apparatus of claim 12, wherein the inorganic particles are surface-treated with at least one of alumina, zirconia, silica and silicone.

20. The electrophotographic imaging apparatus of claim 12, wherein the inorganic particles have an average primary particle diameter of about 10-200 nm.
